(19) United States
(12) Patent Application Publication
(10) Pub. No.: US 2016/0316842 A1
(43) Pub. Date: Nov. 3, 2016

(54) HAT

(71) Applicant: Rick D. Anderson, Minneapolis, MN (US)

(72) Inventor: Rick D. Anderson, Minneapolis, MN (US)

(21) Appl. No.: 15/138,825

(22) Filed: Apr. 26, 2016

Related U.S. Application Data
(60) Provisional application No. 62/154,463, filed on Apr. 29, 2015.

(51) Int. Cl. A42B 1/06; G02C 3/00

(52) U.S. Cl. CPC A42B 1/062; G02C 3/003

(57) ABSTRACT

This invention relates to a hat. In particular, to a hat adapted for clearance around the ears.

### RELATED APPLICATIONS

The present application claims priority to, and incorporates by reference thereto, U.S. Provisional Application No. 62/154,463 filed on Apr. 29, 2015

### BACKGROUND OF THE INVENTION

1. Field

This invention relates to a hat. In particular, to a hat adapted for clearance around the ears.

2. Background

Hats are very common, especially baseball style hats or caps. As shown in FIG. 1 below, this type of hat comprises a forward extending bill and an upper dome portion. The dome or crown portion is frequently comprised of a number of panels and a rim at the bottom of the crown. A button or post cap is often located at that the top of the hat where the panels join together. The rim can include a band to adjust the size of the hat, or just as often the rim is not adjustable and the hats come in different sizes.

On problem with prior art hats of this type occurs where the rim of the hat meets the user's ears, or more precisely the upper portion of the ear lobe. The rim comes close or overlaps with the ear lobes. This creates discomfort. If the rim is located inside the ear lobe it can rub and irate the inner ear lobe. If the rim of the hat goes over the ear lobe it can irate the outside of the earlobe, or irritate the entire upper ear by compressing it between the rim and the head. The problem is worse when the person wearing the hat wears glasses (sunglasses, prescription glasses, or reading glasses). The tines of the glasses must navigate the area where the rim of the hat meets the ears, further decreasing the space available for ear clearance.

The tines can travel over the top of the rim of the hat; however, this creates tension in the glasses causing discomfort. The tines can be placed below the rim of the glasses, but this presses the tines into the top of the ear. Or, the tines can go under the rim of the hat, but this also creates discomfort by pressing the tines into the user's head.

Prior art embodiments include those found in U.S. Patent Pub. No. 20120096625, U.S. Pat. Nos. 6,237,159; 8,740,379; 6,397,396; 5,860,167; 4,179,753; 264,574; 6,647,554 (the foregoing listing of references shall not be construed as an admission that any of the foregoing are material to patentability of the present invention). These references disclose embodiments that suffer from various drawbacks, and/or are not relevant to the problem addressed by the present invention, but are instead provided for reference purposes.

Accordingly, a need exists for a hat that does not create discomfort to the user's ears, especially, when that person is wearing glasses.

### BRIEF DESCRIPTION OF THE FIGURES

FIG. 1 is a side view of a prior art baseball hat.

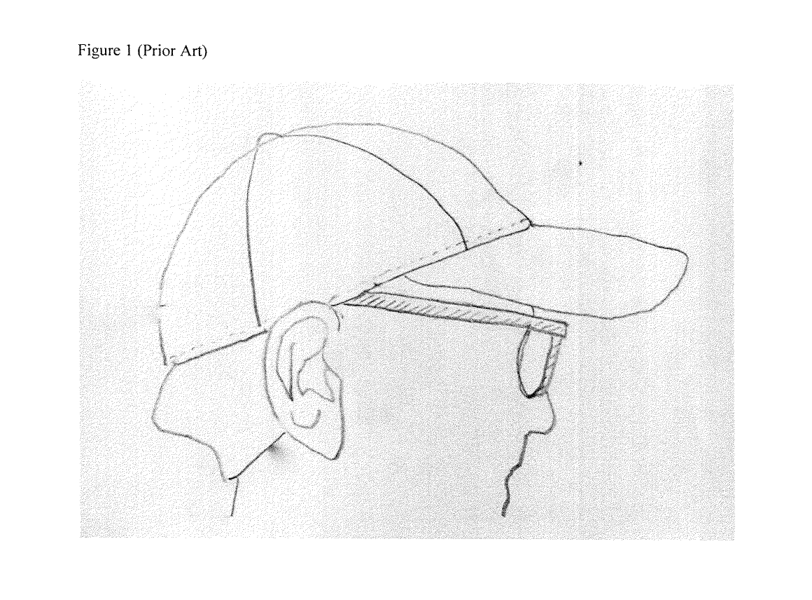

FIG. 2 is a side view of a hat retrofitted in accord with the present invention.

FIG. 3 is side views of three version of the hat of the present invention.

FIG. 4 shows multiple view of the version 1 of the hat, the views being from left to right in the top row: front, side, back, and cut-away side view at the bottom left.

FIG. 5 shows multiple view of the version 2 of the hat, the views being from left to right in the top row: front, side, back, and cut-away side view at the bottom left.

FIG. 6 shows multiple view of the version 3 of the hat, the views being from left to right in the top row: front, side, back, and cut-away side view at the bottom left.

### DETAILED DESCRIPTION OF THE PREFERRED EMBODIMENTS

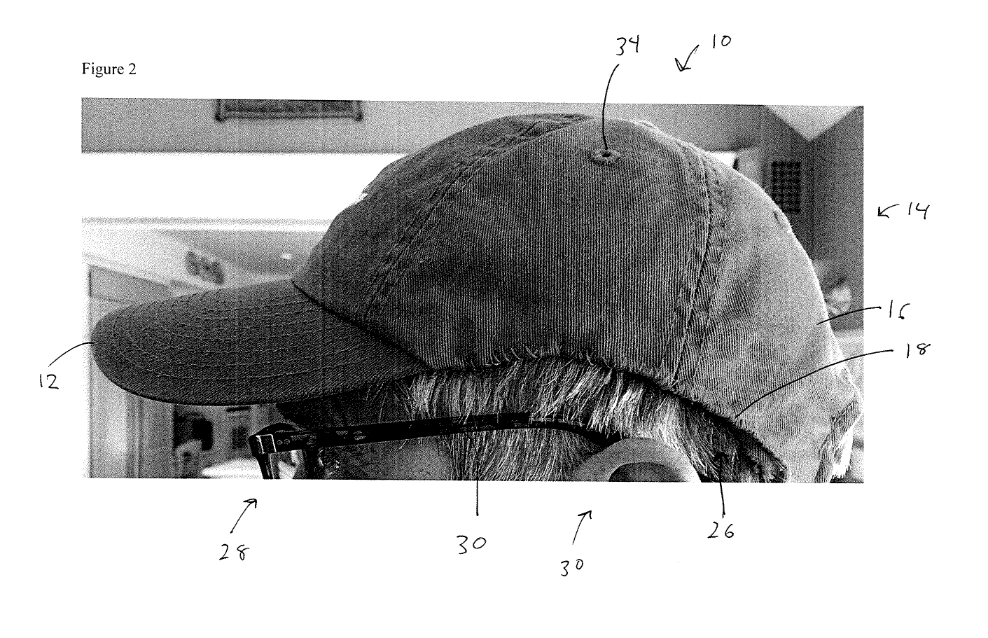

In the Figures, is shown a hat 10 that substantially to completely eliminates the problems of the prior art. In particular, as shown in FIGS. 2-6, the hat 10 is of a type commonly referred to as a baseball hap/cap. The hat 10 comprises a bill 12 that attaches to the bottom front portion of a dome/crown 14. The bill 12 of a baseball hat 10 only covers the front portion of the hat 10, does not extend over to the sides of the hat 10, and provides shade for the face.

The dome 14 of the hat is typically comprised of a plurality of panels 16 that are stitched, or otherwise joined, and that terminate at the top of the hat 10 where a button/post cap 20 is attached at the point where the panels 16 converge. As is described below, not all hats 10 have buttons 20, and the number of and orientation of the panels can and will vary.

The hat 10 also includes a rim 18 along the bottom of the dome 14, which may or may not include a band 36 that can be tightened or loosened with a fastener 24 located at the back of the hat 10. This configuration allows for adjusting the hat 10 to fit different user head sizes. As an alternative, the hat 10 many have a stationary nonadjustable rim 18, and then come in different sizes to accommodate user preferences as to fit.

The rim 18 of the hat 10 comprises two curved or raised portions 26 on either side of the hat 10 over the ears 32. This creates a sizable gap between the bottom of the hat 10 and the top of the ear 32 such that the hat 10 does not impact/contact the top of the ear 32 with, or without glasses 28. The hat 10 can be altered to remove a portion of the rim 18 (as in retrofitting existing hats that have the typical uniform circumferential rim found in the prior art—see FIG. 2), or the hat 10 can be constructed with a curved, raised, or arched portion 26 of the rim 18 of the hat 10 over the ear area, wherein the rim 18 is appropriately distanced from the ear.

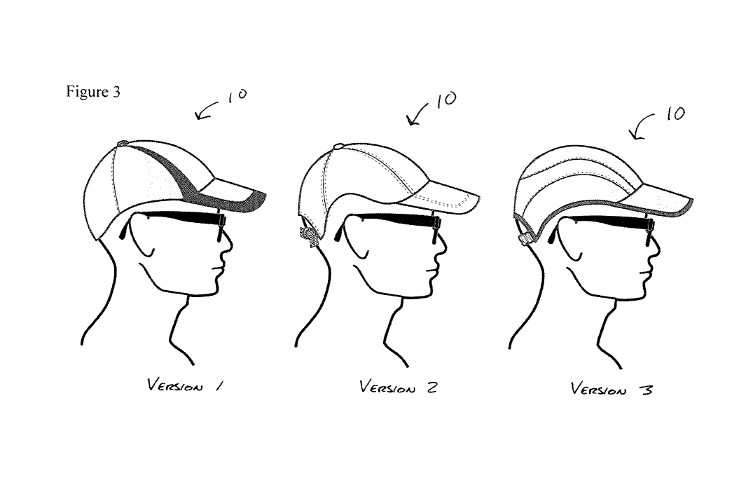

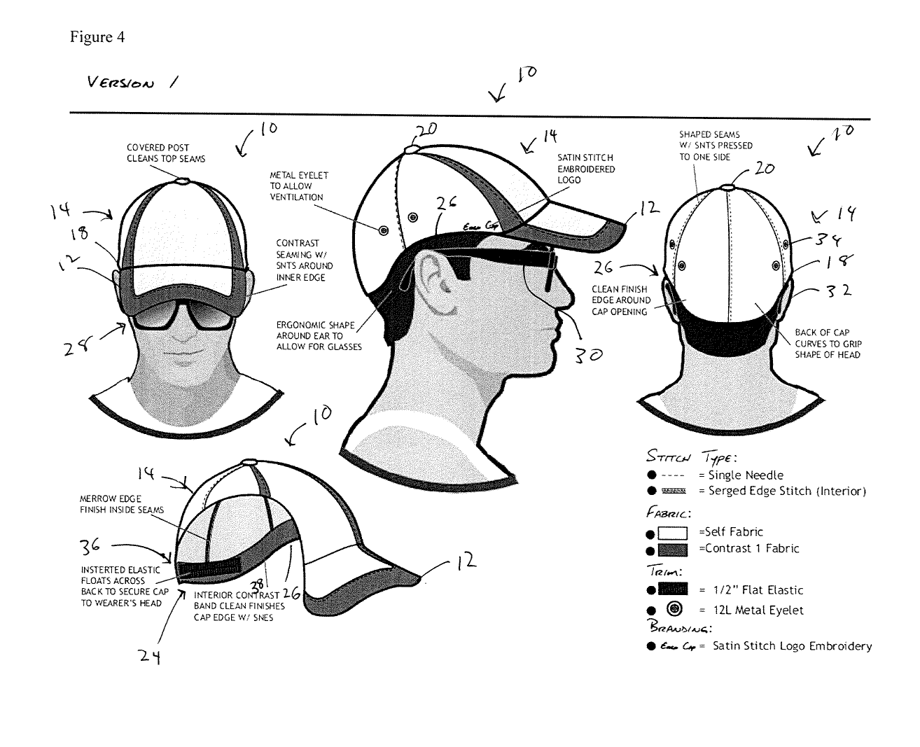

FIG. 3 shows in profile, views of three different configurations of the hat 10 of the present invention. In particular, FIG. 4 is a close up view of version 1 of the hat 10 shown in in FIG. 3. The hat 10 includes a bill 12, dome 14, and a plurality of panels 16 that terminate in a button 20. The rim 18 includes curved sections 26 over each ear to easily accommodate the tines 30 of glasses 28 without any interference by the hat 10. Eyelets 32 in the panels 16 are provided for ventilation. The inside of the dome 14 of the hat 10 at the back has an elastic band 36. The band 36 gently resists expansion when the hat 10 is worn in order to provide a comfortable and secure fit. Further, the back of the dome 14 of the hat 10 is curved or sloped to match the contour of the users head to provide a better and more secure fit.

The seams of the panels 16 are generally stitched (with a single needle top stitch), and the seams are pressed to one side for comfort. A contrast band 38 secures to the inside bottom of the dome 14 and is secured with single needle edge stich.

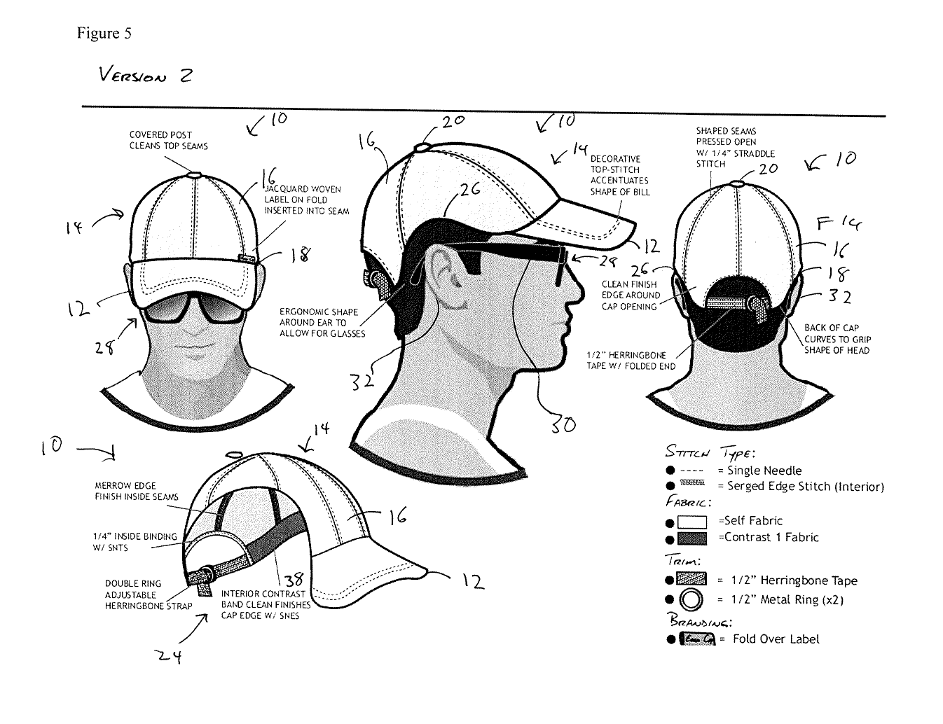

FIG. 5 is a close up view of version 2 of the hat 10 shown in FIG. 3. The hat 10 includes a bill 12, dome 14, and a plurality of panels 16 that terminate in a button 20. The rim 18 includes curved sections 26 over each ear to easily accommodate the tines 30 of glasses 28 without any interference by the hat 10. The hat 10 further comprises a fastener 24, which allows the hat 10 to be adjusted to the user's head size. Fastener 24 is a double ring through which a strap is threaded for a controlled and adjustable fit. The configuration of the panels 16 varies from that of the hat 10 of FIG. 4.

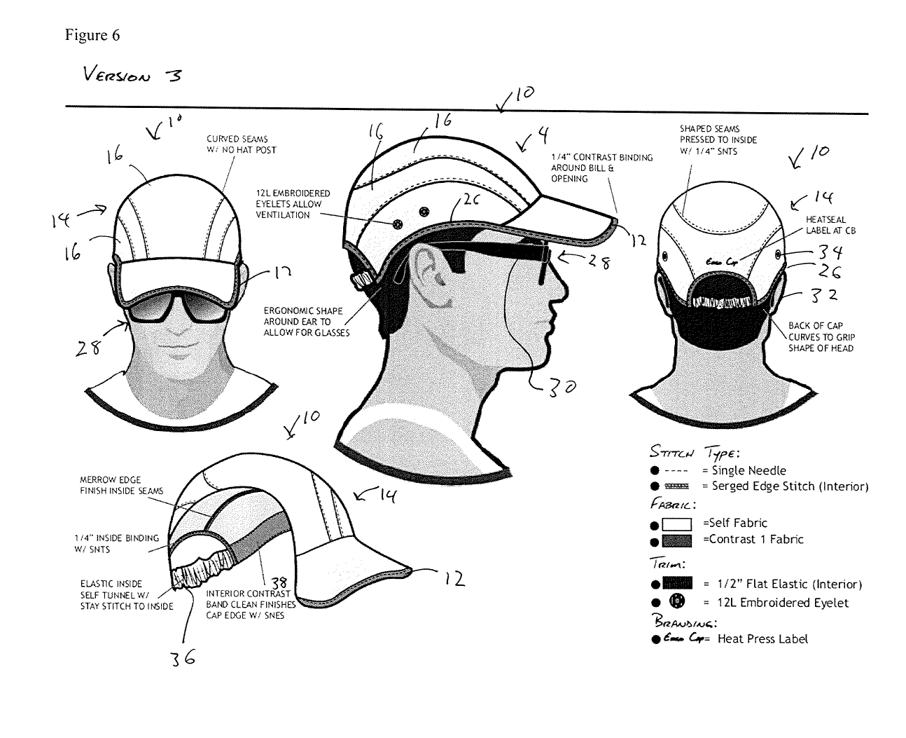

FIG. 6 is a close up view of version 3 of the hat 10 shown in in FIG. 3. The hat 10 includes a bill 12, dome 14, a plurality of panels 16, but does not terminate in a button as shown in the other versions. The rim 18 includes curved sections 26 over each ear to easily accommodate the tines 30 of glasses 28 without any interference by the hat 10. The configuration of the panels 16 varies from the other versions in that the panels are more circumferential in orientation rather than radial (as in version 1 and 2).

The hat 10 includes a fastener 24, which is an elastic band that compresses to varying degrees based on the size of the user's head.

The prior art included hats that have pockets or slots in the hat to receive the tines of a glasses, however, this does not solve the problem as the glasses are now tight against the users head, and it complicates the manufacture of the hat. Further, these designs generally are for storing glasses when not worn and would not be or any use when the user actually wears the glasses. Also, while not addressing the problem solved by the present invention, these designs may negatively affect the aesthetics of the hat in the mind of many users. The present invention solves these problems by allow the user to wear a hat and wear glasses in the same manner as if the hat was not present. Also, the appearance of the hat is not negatively affected; in fact, the hat can even be more attractive in appearance. Because less material is used the hat should be incrementally less expensive to manufacture.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods, and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention. For example, the invention can be used with any style of hat that encloses the area around or above the ear such as baseball hats, leather hats, barmah hats, panama hats, ascot caps, bowlers, pork pie hats, sun hats, straw hats, top hats, western hats, travel hats, safari hats, helmets, flat hats, berets, fezzes, fisherman caps, cadet hats, military hats, and the like.

1. A hat, having a front, back, first and second sides, and a top, comprising:
a dome the encompasses and defines the front, back, sides, and top of the hat;
a bill connected to and extending outward from the front of the front of the dome;
a rim extending around and along the bottom of a substantial portion of the sides of the of the dome;
wherein the rim is curved upward so as to be adapted to provide substantial clearance over the lobes of a user's ears.

2. The hat of claim 1 wherein the dome is comprised of at least one panel.

3. The hat of claim 2 wherein the dome is comprised of a plurality of panels.

4. The hat of claim 3 wherein the panels are orientated radially.

5. The hat of claim 3 wherein the panels are orientated circumferentially.

6. The hat of claim 1 further comprising a fastener for adjusting the size of the hat.

7. The hat of claim 6 where the fastener is located at the back of the hat.

8. The hat of claim 6 where the fastener is an elastic band.

9. The hat of claim 8 where the elastic band is built into the inside of the rim.

10. The hat of claim 6 where the fastener is a ring and strap.

11. The hat of claim 6 where the fastener is two rings and a strap.

12. The hat claim 1 wherein the back of the dome slopes downward to conform to the shape of a person's head.

13. A hat, having a front, back, first and second sides, and a top, comprising:
a dome the encompasses and defines the front, back, sides, and top of the hat;
a plurality of panels that comprises the dome;
a bill connected to and extending outward from the front of the front of the dome;
wherein the panels are curve upward so as to be adapted to provide substantial clearance over the lobes of a user's ears.

14. A hat and glasses, the hat having a front, back, first and second sides, and a top, comprising:
a hat dome the encompasses and defines the front, back, sides, and top of the hat;
a plurality of panels that comprises the dome;
a hat bill connected to and extending outward from the front of the front of the dome;
wherein the panels are curve upward so as to be adapted to provide substantial clearance over the lobes of a user's ears;
glasses having tines that releasably secure them in place over a user's ears and when the user is wearing the hat do not come into contact with the hat.
